(19) United States
(12) Patent Application Publication
(10) Pub. No.: US 2026/0249723 A1
(43) Pub. Date: Aug. 27, 2026

(54) Light Electric Vehicle Parking and Charging System

(71) Applicant: STANDAB AB, NACKA (SE)

(72) Inventors: Henrik Ribbing, Saltsjöbaden (SE); Marcus Adolfsson, Saltsjöbaden (SE); Christer Myhran, Saltsjöbaden (SE); Erik Bergqvist, Stockholm (SE)

(21) Appl. No.: 19/642,696

(22) Filed: Apr. 9, 2026

Related U.S. Application Data
(63) Continuation of application No. PCT/SE2024/050769, filed on Sep. 5, 2024.

(30) Foreign Application Priority Data
Oct. 9, 2023 (SE) 2351158-7

(51) Int. Cl. B60L 53/34; B60L 53/126; B60L 53/30; B60L 53/31; B60L 53/36; B60L 53/65; B60L 53/66

(52) U.S. Cl. CPC B60L 53/34; B60L 53/126; B60L 53/305; B60L 53/31; B60L 53/36; B60L 53/65; B60L 53/66

(57) ABSTRACT

A connector for parking and charging an LEV (Light Electric Vehicle) includes an LEV support structure connector, and an LEV connector. The LEV support structure connector is configured to be mounted on an LEV support structure. The LEV connector is configured to be mounted on an LEV. The connectors, respectively, include a front connector plate arranged to cooperate with a corresponding connector plate at the other connector. The LEV support structure connector, the LEV connector, or both, include a magnetic material or a magnet, for cooperating with corresponding magnet or magnetic material of the other connector to pull the connectors together when brought close to one another; and a rubber bushing, to cushion and align the front connector plates to one another when a user places the LEV into the LEV support structure, thereby assisting in creating the magnetic connection between the LEV support structure connector and the LEV connector.

### BACKGROUND

The present application relates to parking and charging Light Electric Vehicles (LEVs), such as electric scooters, electric bicycles (e-bikes), and so on.

An LEV is a category of electric vehicles that includes a wide range of small and lightweight vehicles designed for short-distance travel. These vehicles are typically powered by electric motors and use batteries as their energy source. LEVs are often chosen for their efficiency, low environmental impact, and suitability for urban commuting and short trips. Common types of LEVs include electric bicycles (e-bikes), electric scooters, electric skateboards, and electric kick scooters.

Parking and charging for LEVs can vary depending on the type of vehicle and the infrastructure available in a particular area. E-bikes can often be parked at bicycle racks just like traditional bicycles. Many cities have dedicated bike racks and bike sharing programs. Electric scooters and kick scooters are often parked in designated zones or docking stations. Some cities have established specific parking areas or corrals for these vehicles to keep them organized and prevent clutter.

E-bike batteries can typically be charged by removing the battery pack and plugging it into a standard electrical outlet using an electrical cord. Electric scooters used in shared scooter programs are typically maintained by the companies that provide the electric scooters. These companies have staff who regularly collect scooters, charge them at central facilities, and redistribute them to designated pickup points. Some cities are also developing public charging infrastructure specifically for LEVs. This may include dedicated charging stations in popular areas, such as shopping centers or transportation hubs. Charging costs for shared LEVs (e.g., scooter rentals) are usually included in the rental fee. Users typically pay for the time they use the vehicle, and the companies manage the charging. Batteries can also be removed from shared LEVs and replaced with a recharged battery, batteries being recharged at a central location

As the regulations and infrastructure for LEVs can vary widely from one city or region to another, it is often necessary for users to familiarize themselves with local rules and available services when using or parking your LEV. This can sometimes create a barrier for the adoption of LEVs, and there may also be a number of challenges associated with maintaining a patchwork of related infrastructure. Thus, there is plenty of room for improvements with respect to parking and charging LEVs.

### BRIEF SUMMARY

In one aspect, an LEV (Light Electric Vehicle) support structure connector for use when parking and charging an LEV, includes a first connector component configured to be mounted on an LEV support structure. The first connector component includes a first front connector plate being arranged to cooperate with a second front connector plate of a second connector component of an LEV connector, either a magnetic material or a magnet, arranged to cooperate with corresponding magnet or magnetic material, respectively, of the LEV connector to pull the first and second connector components together when brought in proximity with one another, and a rubber bushing, arranged to provide cushioning and to allow for horizontal and vertical movement to aid the magnet in aligning the front connector plates to one another when a user places the LEV into the LEV support structure.

In one aspect, an LEV (Light Electric Vehicle) connector for use when parking and charging an LEV, includes a second connector component configured to be mounted on an LEV. The second connector component includes a second front connector plate being arranged to cooperate with a first front connector plate of a first connector component of an LEV support structure connector, either a magnetic material or a magnet, arranged to cooperate with corresponding magnet or magnetic material, respectively, of the first connector to pull the first and second connector components together when brought in proximity with one another, and a rubber bushing, arranged to provide cushioning and to allow for horizontal and vertical movement to aid the magnet in aligning the front connector plates to one another when a user places the LEV into the LEV support structure.

In one aspect, a connector for use when parking and charging an LEV (Light Electric Vehicle), includes an LEV support structure connector, and an LEV connector.

In some embodiments, the first connector component and the second connector component can include nearfield communication hardware, such as NFC circuitry, allowing data to be exchanged between the LEV and the LEV support structure when the LEV is parked at the LEV support structure.

In some embodiments, the data exchanged between the LEV and the LEV support structure can include data pertaining to the identity and status of the LEV.

In some embodiments, the magnet can be installed in the first connector component and the second connector component can include a metal plate that attracts the magnet when the LEV is placed in the LEV support structure.

In some embodiments, the front connector plate of the first connector component can include electrical connectors electrically connected to a power grid, and the front connector plate of the second connector component can include corresponding electrical connectors electrically connected to a battery of the LEV, so as to transfer electricity and enable charging of the LEV when the front connector plates are in contact with one another.

In some embodiments, the first connector component can be provided with a guide operable to assist with aligning the front connector plate to one another when inserting the LEV into the LEV support structure.

In some embodiments, the guide can be funnel-shaped to enable insertion of the second connection component in an off-center position, and the diagonal sections of the funnel can form an angle of approximately 25-40 degrees with respect to one another at a wide end of the guide, and narrowing down to form an angle of approximately 3-12 degrees with respect to one another at a narrow end of the guide.

In some embodiments, the guide can have sides that are flat in a vertical plane and the second connector component can have corresponding sides that are flat in the vertical plane so as to prevent the second connector component from rotating with respect to the first connector component when placing the LEV in the LEV support structure.

In some embodiments, the magnet can be a permanent magnet.

In some embodiments, the front connector plate can be flat and include embedded contactors.

In some embodiments, the front connector plate can be rectangular.

In some embodiments, the front connector plate can move in a horizontal and/or a vertical direction as a result of bending the rubber bushing.

In some embodiments, the LEV can be held by the LEV support structure through magnetic force only when the LEV is placed in the LEV support structure.

In one aspect, an LEV support structure is provided. The LEV support structure comprises a plurality of support structure connectors.

In one aspect, an LEV is provided. The LEV comprises an LEV connector as described above.

Other technical features may be readily apparent to one skilled in the art from the following figures, descriptions, and claims.

### BRIEF DESCRIPTION OF THE DRAWINGS

To easily identify the discussion of any particular element or act, the most significant digit or digits in a reference number refer to the figure number in which that element is first introduced.

FIG. 1A is a schematic side plan view of an LEV support structure 102 containing a number of LEV support structure connectors 104, in accordance with some embodiments.

FIG. 1B is a schematic top plan view of the LEV support structure 102 of FIG. 1A.

FIG. 2 is a schematic view of a scooter (i.e., a type of LEV) including an LEV connector 204, in accordance with some embodiments.

FIG. 3 is an exploded view of a first connector component 104, in accordance with some embodiments.

FIG. 4 is an exploded view of the first connector component 104, shown in FIG. 3, but from a different perspective.

FIG. 5 is an exploded view of a second connector component 204, in accordance with some embodiments.

Like reference numerals in the drawings indicate like features.

### DETAILED DESCRIPTION

The various embodiments described herein relate to techniques for parking and charging Light Electric Vehicles (LEVs). A connector is described, which includes two major components; an LEV support structure connector, to be mounted on some type of LEV support structure, such as an electric scooter docking station, and an LEV connector to be mounted on the LEV, such as an electric scooter. The connector is used when docking an LEV at the LEV support structure, and is unique compared to conventional parking and charging solutions for LEVs by using, among other things, magnet(s), and rubber bushings, as will be described in further detail below. The magnet(s) is/are installed in LEV support structure connector and/or the LEV and ensures a solid/successful fit between the two connector parts, such that the LEV can be securely placed at the LEV support structure without using any dedicated locking mechanisms.

The rubber bushing on the LEV support structure connector and/or the LEV connector provides flexibility that enables a successful docking and charging sequence, even when surface beneath the LEV support structure is uneven. It also allows different makes of LEVs to share the same LEV support structure, even if the LEVs have different heights. Overall, the magnet(s) and the rubber bushings enable an easy insertion and a cable-free charging sequence of an LEV in the LEV support structure.

As will also be described in further detail below, the LEV support structure can be connected to the public grid and installed in the public domain, without requiring users of the LEVs to plug in cables and/or perform additional steps that may be necessary to secure the LEV to the LEV support structure. By using the various embodiments of the connector described herein, easy insertion of the LEV into the LEV support structure, secure parking, and easy intentional removal of the LEV from the LEV support structure can be accomplished. In addition, by connecting the LEV support structure to a computer network, such as the Internet, through a wired or wireless connection, a number of operations with respect to the LEVs can also be performed while the LEVs are parked at the LEV support structure, for example, by using various cloud services, as will be described in further detail below.

Various embodiments of the invention will now be described in further detail by way of example and with reference to the drawings. It should be noted that while the examples below refer to embodiments where the LEV is an electric scooter and the LEV support structure is a docking station, the general principles of the different embodiments of the invention are equally applicable to other types of LEVs and LEV support structures. As was noted above, common types of LEVs today include e-bikes, electric scooters, electric skateboards, and electric kick scooters, but there may also be future types of LEVs that may benefit from the general principles described herein.

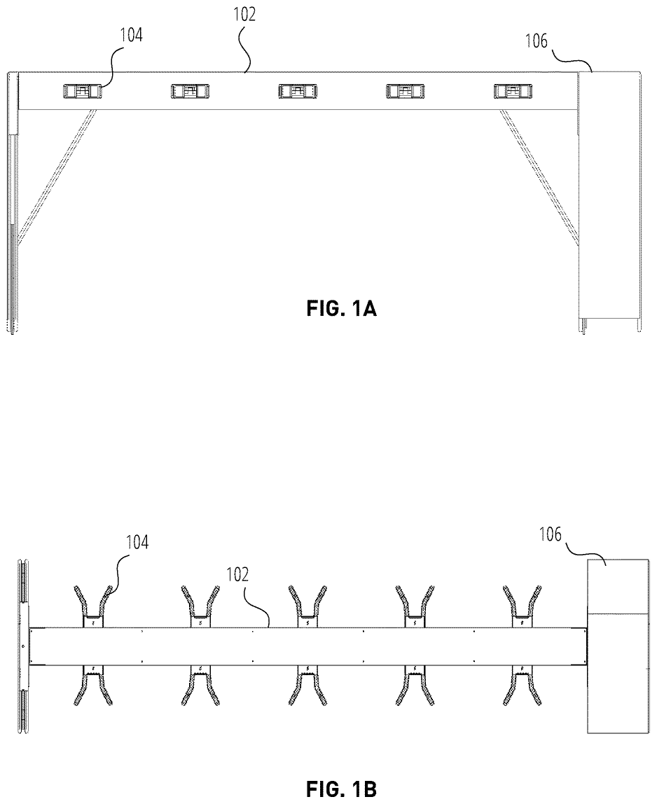

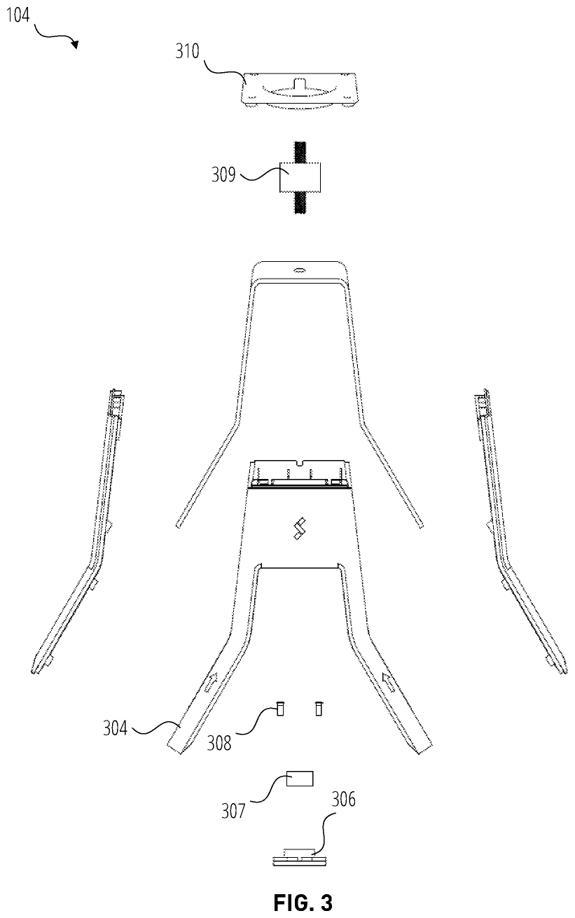

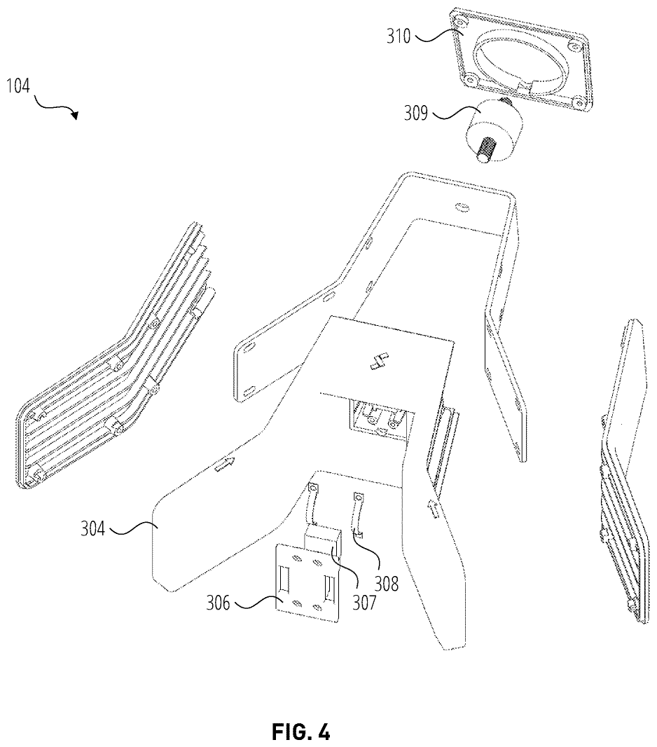

FIG. 1A shows a schematic side plan view of an LEV support structure 102 including several LEV support structure connectors 104, in accordance with some embodiments. A corresponding schematic top plan view is shown in FIG. 1B. The LEV support structure connectors 104 will be described in further detail below with reference to FIG. 3 and FIG. 4. The LEV support structure 102 can have many physical appearances, but commonly the LEV support structure 102 is free-standing to allow for easy installation in a variety of locations, such as either up against a wall, where only one side of the LEV support structure 102 is used for parking LEVs 202, or in an open space, such as a square, where both sides may be used. Some embodiments of the LEV support structure 102 include built-in weights (e.g., steel weights), which further ensures the stability of the LEV support structure 102. The free-standing design also provides the flexibility to assess and evaluate various parking areas before making a permanent installation, making it a versatile solution for a range of urban environments.

The LEV support structure 102 in FIG. 1A includes a power and communication module 106 that is connected to the power grid and the respective LEV support structure connectors 104 to enable charging of the LEVs 202 that are parked at the LEV support structure 102. Appropriate circuitry is provided in the power and communication module 106 to convert the power supplied by the power grid and deliver the proper current and voltage to the LEVs 202. How to accomplish this is well known by those having ordinary skill in the art, and will therefore not be explained here in any further detail.

In the illustrated embodiment, the power and communication module 106 is also connected to the Internet, either through a wired or a wireless connection, to enable communication with, for example, various cloud services. As will be explained in further detail below, the LEV support structure connectors 104 are equipped with NFC circuitry that enables exchange of data with the LEVs, so by enabling the LEV support structure 102 to communicate with the Internet, data can be transferred between the LEVs and various services by means of the NFC circuitry and the power and communication module 106. This makes it possible to determine what LEVs are parked at the LEV support structure 102 at any given time, since each LEV is provided with an identifier. The LEV data can then be used in a variety of ways, ranging from providing incentives to users for properly parking their LEV to statistics for LEV providers and/or municipalities about the overall use of the LEVs.

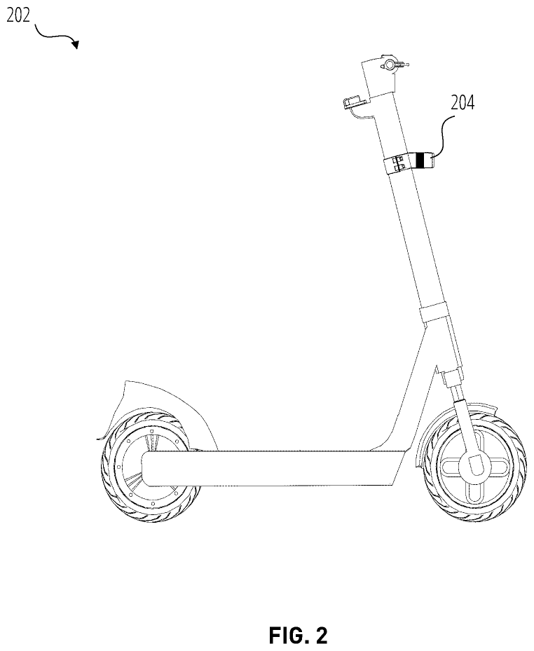

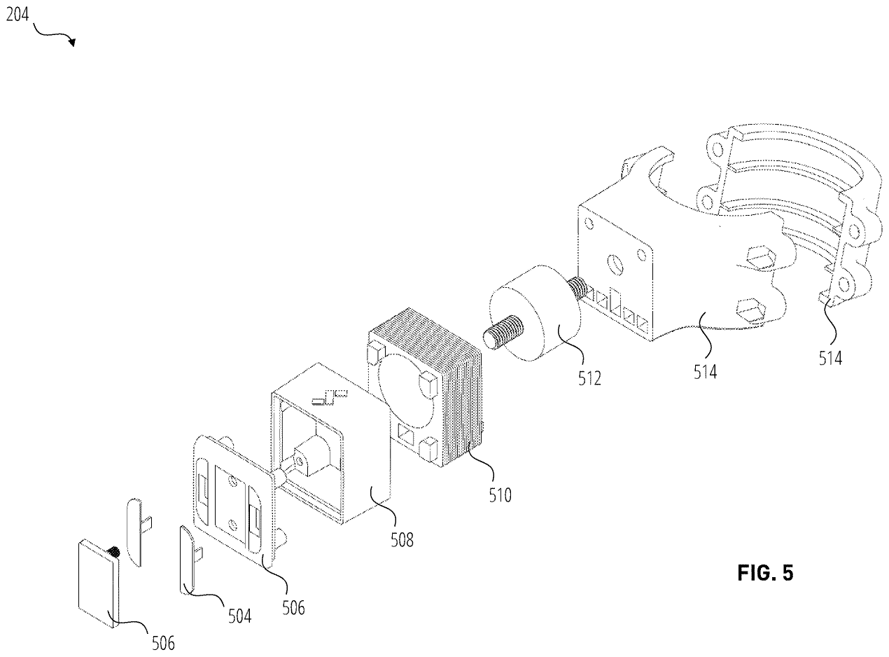

FIG. 2 is a schematic view of a scooter (i.e., a type of LEV 202) including an LEV connector 204, in accordance with some embodiments. The LEV connector 204 is placed at a predetermined height above ground that matches the height of the LEV support structure connector 104 in the LEV support structure 102. The LEV connector 204 will be described in further detail below with reference to FIG. 5, but again it is noted that both the 204 and the LEV support structure connector 104 are provided with rubber bushings, which allow the LEV support structure connector 104 and the LEV connector 204 to accommodate for smaller height differences and align even if the ground below is uneven.

FIG. 3 is an exploded top-down view of a first connector component 104, in accordance with some embodiments. FIG. 4 shows the same components that are shown in FIG. 3, but from a different angle that is more similar to what a user will experience when parking her LEV 202 at the LEV support structure 102. As shown in FIG. 3 and FIG. 4, the first connector component 104 includes a guide 304 whose purpose is to “catch” the vertical part of the electric scooter 202, where the LEV connector 204 (also referred to as the second connector component 204) is mounted, and guide the electric scooter into its proper parked position in the LEV support structure 102.

As shown in FIG. 3 and FIG. 4, the guide 304 has a funnel-like shape with a relatively wide opening, typically approximately 15-30 cm and an angle between the outer part of the arms of the guide 304 of approximately 25-40 degrees, preferably 27-38 degrees. This makes it easy for a user to insert the electric scooter into the opening of the guide 304. A few cm inside the opening, the guide narrows to a width of approximately 5-15 cm, preferably 7-14 cm, and an angle between the inner part of the arms of approximately 3-12 degrees, preferably 4-10 degrees. This narrowing allows both more secure parking of the electric scooter in the LEV support structure 102, and better alignment of the first connector component 104 and the second connector component 204. The guide 304 can be constructed in a variety of ways. In the illustrated embodiment in FIG. 3 and FIG. 4, respectively, there is a metal structure that serves as a base of the guide 304, and which is covered by plastic cover plates to provide a smooth surface to avoid scratching the electric scooter, protect any internal components and connections, and to provide an aesthetically pleasing appearance.

The inner surfaces of the embodiment of the guide 304 that is shown in FIG. 3 are flat in a vertical plane. Corresponding vertical flat surfaces are provided on the second connector component 204 that is mounted on the electric scooter. This arrangement is advantageous since it ensures that the electric scooter is inserted in a straight up position into the LEV support structure connector 104, rather than leaning to one side or the other, thereby ensuring a better fit of the first connector component 104 and the second connector component 204 when the user parks the electric scooter at the LEV support structure connector 104. It should however be noted that in some embodiments, the guide 304 might have a different geometry (e.g., conical, or semi-spherical) that is adapted to the particular geometry of the LEV 202, where it may be acceptable for the LEV 202 to be inserted at an angle relative to the LEV support structure connector 104. Such modifications can be accomplished by those having ordinary skill in the art.

The first connector component 104 includes a first front connector plate 306 that is arranged to cooperate with a corresponding second front connector plate 506 of the second connector component 204 on the electric scooter when the electric scooter is parked at the LEV support structure connector 104. The first front connector plate 306 is made of metal and has a rectangular or square shape in the illustrated embodiment, but can of course have other shapes and be made of other materials depending on the particular situation at hand, such as the type of LEV and the configuration of the second connector component 204 on the LEV. In the illustrated embodiment in FIG. 3 and FIG. 4, the first front connector plate 306 has a size of 4.7 by 3.7 cm and has two slits into which two embedded contactors 308 are provided. The embedded contactors 308 are configured to deliver power to two corresponding embedded contactors 504 in the second connector component 204 on the electric scooter to charge the battery of the electric scooter, as will be discussed in further detail below with reference to FIG. 5. It should be noted that this is merely one exemplary embodiment, and that in other embodiments, the size of the first front connector plate 306 and number of embedded contactors 308 may be different.

In the embodiment illustrated in FIG. 3 and FIG. 4, a magnet 307 or magnetic material is placed behind the first front connector plate 306, in between the embedded contactors 308. Depending on the embodiment, at least one of the first connector component 104 and second connector component 204 contains a magnet, and the other connector component may contain either a magnetic material or a magnet. The magnet 307 or magnetic material is arranged to cooperate with corresponding magnet or magnetic material, respectively, of the second connector component 204 to pull the first connector component 104 and second connector component 204 together when brought in proximity with one another. Thus, when the electric scooter is inserted into the guide 304 by a user, the first connector component 104 and second connector component 204 are brought together by an attractive magnetic force, which serves to hold the electric scooter into place at the LEV support structure connector 104 until a user decides to remove the electric scooter from the LEV support structure connector 104.

The magnet 307 is typically a permanent magnet, such as a neodymium magnet, although other types of permanent magnets, such as alnico or ferrite magnets could also be used. It should be noted that there are also embodiments in which electromagnets can be used, although this also increases the complexity and expense of the first connector component 104, due to the additional electrical connection requirements, so therefore permanent magnets are generally desirable. The general constraints that dictate the choice of magnet 307 is that it should be strong enough to assist the user of the electric scooter to park the electric scooter properly and force the first front connector plate 306 and second front connector plate 506 to align themselves and connect in an accurate way, which is facilitated by a rubber bushing 309, which will be described below. The magnet also makes a docked LEV more resilient to getting un-docked or falling due to outer forces such as a collision impact from another LEV being poorly parked next to it. Together, the attractive force of the magnet 307 and the flex/shock absorption from the rubber bushing 309 increase the chances of successful docking and charging of the LEV in the LEV support structure connector 104.

The first connector component 104 further includes a back plate 310 that is used to secure the first connector component 104 to the LEV support structure connector 104. Typically, the back plate 310 is secured to the first connector component 104 via a rubber bushing 309 to both provide cushioning when the LEV is inserted into the LEV support structure connector 104, and to allow for horizontal and vertical movement of the first connector component 104 to allow its first front connector plate 306 to properly align with the corresponding second front connector plate 506 on the electric scooter when the user places the electric scooter into the LEV support structure, as described above. In the illustrated embodiment, the rubber bushing 309 can be of the same type as rubber bushings that are used today as a mount for, for example, an AC device. In addition to compensating both for height differences in the ground beneath and poor steering while docking, the rubber bushing 309 also absorbs the impact from docking, and thus reduces wear on all components of the first connector component 104, whilst giving the user a docking experience with a “smooth feel” rather than a “hard clunk” as the electric scooter is inserted into the LEV support structure connector 104. A corresponding rubber bushing 510 may be provided on the second connector component 204 of the electric scooter to enhance these aspects of the invention even further, as will be described below with reference to FIG. 5.

FIG. 5 is an exploded view of a second connector component 204. Many of the components that are included in the second connector component 204 have corresponding counterparts in the first connector component 104 above and will therefore not be described in great detail below. Briefly, the second connector component 204 includes a second front connector plate 506, which has a matching configuration to the first front connector plate 306 of the first connector component 104. The second front connector plate 506 has two embedded contactors 504 that match the positions of the embedded contactors 308 of the first connector component 104, and which are connected to the battery of the LEV to enable charging of the LEV when parked at the LEV support structure 102, as described above. The second front connector plate 506 is made from a magnetic material, to cooperate with the magnet 307 of the first connector component 104.

The second connector component 204 further includes NFC circuitry 508 as discussed above, which can be used, for example, to transfer data from the LEV to various cloud applications via the power and communication module 106 of the LEV support structure 102, as discussed above. For example, the NFC circuitry 508 can be used to perform functions such as “end ride” without the need of the user taking a photo or interacting with a dedicated app on his or her cell phone, as is common in today's systems.

The second connector component 204 illustrated in FIG. 5 further includes a rubber bushing 510. Just like the rubber bushing 309 in the first connector component 104, the purpose of the rubber bushing 510 is to provide cushioning and to allow for horizontal and vertical movement of the front connector plate to aid the magnet(s) in aligning the front connector plates to one another when a user places the LEV into the LEV support structure 102.

As was noted above, in this embodiment no magnet is provided, but rather the second front connector plate 506 is made from a magnetic material that is attracted by a magnet in the first connector component 104. However, as described above, this is only one example embodiment, and there may be other embodiments in which a magnet is also provided in the second connector component 204, in addition to, or instead of the second front connector plate 506.

Lastly, an LEV attachment clamp 514 is used to attach the second connector component 204 around the vertical pole of the electric scooter. It should be noted that this is merely one example of attachment mechanism, and that there may be many others that are available to those having ordinary skill in the art, such that the second connector component 204 can be attached at an appropriate height of the electric scooter and accommodate electric scooters and LEVs of different brands.

While this specification contains many implementation details, these should not be construed as limitations on the scope of the invention or of what may be claimed, but as descriptions of features specific to implementations of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. Thus, unless explicitly stated otherwise, or unless the knowledge of one of ordinary skill in the art clearly indicates otherwise, any of the features of the embodiment described above can be combined with any of the other features of the embodiment described above.

Similarly, while operations are depicted in the drawings in a particular order, this should not be understood as requiring that such operations be performed in the order shown or in sequential order, or that all illustrated operations be performed, to achieve desirable results. The separation of various system components in the embodiments described above should not be understood as requiring such separation in all embodiments.

Thus, embodiments of the invention have been described. Other embodiments are within the scope of the following claims. For example, instead of using rubber bushings, other types of 360-degree joints may be used in combination with a shock absorber. As was noted above, the magnet can be an electromagnet. The magnets can be placed such that a pushing force rather than a pulling force causes the LEV to remain in the slot. The front connector plates can be changed to provide an inductive contact. The same principles can be used to charge and/or organize products other than LEVs.

It should also be noted that whereas the examples above have been presented as different categories of embodiments, it is also possible to combine these categories of embodiments. That is, they are non-exclusive. For example, there may be embodiments in which there is only a single magnet, which may be placed in either the first connector component 104 or the second connector component 204, and there may be embodiments in which each connector component includes a magnet. Similarly, there may be embodiments in which there is only one rubber bushing, which may be placed in either the first connector component 104 or the second connector component 204, and there may be embodiments in which each connector component includes a rubber bushing, etc. Thus, it should be clear that various combinations of the above examples can also be made, and that many variations to the above examples lie well within the scope of the attached claims and within the capabilities of a person having ordinary skill in the art.

What is claimed is:

1. An LEV (Light Electric Vehicle) support structure connector for use when parking and charging an LEV, the LEV support structure connector being configured to be mounted on an LEV support structure, comprising:
a first front connector plate being arranged to cooperate with a second front connector plate of an LEV connector mounted on the LEV;
either a magnetic material or a magnet, arranged to cooperate with a magnet or magnetic material, respectively, of the LEV connector to pull the LEV support structure connector and the LEV connector together when brought in proximity with one another, and to hold the LEV support structure connector and the LEV connector together solely by magnetic force when the LEV is parked at the LEV support structure; and
a rubber bushing, arranged to provide cushioning and to allow for horizontal and vertical movement to align the front connector plates to one another when a user places the LEV into the LEV support structure, thereby assisting in creating the magnetic connection between the LEV support structure connector and the LEV connector.

2. An LEV (Light Electric Vehicle) connector for use when parking and charging an LEV, the LEV connector being configured to be mounted on the LEV, comprising:
a second front connector plate being arranged to cooperate with a first front connector plate of an LEV support structure connector according to claim 1;
either a magnetic material or a magnet, arranged to cooperate with a magnet or magnetic material, respectively, of the LEV support structure connector to pull the LEV connector and the LEV support structure connector together when brought in proximity with one another, and to hold the LEV support structure connector and the LEV connector together solely by magnetic force when the LEV is parked at the LEV support structure; and
a rubber bushing, arranged to provide cushioning and to allow for horizontal and vertical movement align the front connector plates to one another when a user places the LEV into the LEV support structure, thereby assisting in creating the magnetic connection between the LEV support structure connector and the LEV connector.

3. A connector for use when parking and charging an LEV (Light Electric Vehicle), comprising:
an LEV support structure connector according to claim 1; and
an LEV connector according to claim 2.

4. The connector of claim 3, wherein the LEV support structure connector and the LEV connector comprise nearfield communication hardware, such as NFC circuitry, allowing data to be exchanged between the LEV and the LEV support structure when the LEV is parked at the LEV support structure.

5. The connector of claim 4, wherein the data exchanged between the LEV and the LEV support structure includes data pertaining to the identity and status of the LEV.

6. The connector of claim 3, wherein the magnet is installed in the LEV support structure connector and the LEV connector includes a metal plate that is attracted to the magnet when the LEV is placed in the LEV support structure.

7. The connector of claim 3, wherein the front connector plate of the LEV support structure connector comprises electrical connectors electrically connected to a power grid, and the front connector plate of the LEV connector comprises corresponding electrical connectors electrically connected to a battery of the LEV, so as to transfer electricity and enable charging of the LEV when the front connector plates are in contact with one another.

8. The connector of claim 3, wherein the LEV support structure connector includes a guide operable to assist with aligning the front connector plates to one another when inserting the LEV into the LEV support structure.

9. The connector of claim 8, wherein the guide is funnel-shaped to enable insertion of the LEV connector in an off-center position, and where the diagonal sections of the funnel form an angle of approximately 25-40 degrees with respect to one another at a wide end of the guide, and narrowing down to form an angle of approximately 3-12 degrees with respect to one another at a narrow end of the guide.

10. The connector of claim 9, wherein the guide has sides that are flat in a vertical plane and the LEV connector has corresponding sides that are flat in the vertical plane so as to prevent the LEV connector from rotating with respect to the LEV support structure connector when placing the LEV in the LEV support structure.

11. The connector of claim 3, wherein the magnet is a permanent magnet.

12. The connector of claim 3, wherein the front connector plate is flat and includes embedded contactor.

13. The connector of claim 3, wherein the front connector plate is rectangular.

14. The connector of claim 3, wherein the front connector plate is operable to move in a horizontal and/or a vertical direction as a result of bending the rubber bushing.

15. An LEV (Light Electric Vehicle) support structure comprising a plurality of LEV support structure connectors according to claim 1.

16. An LEV (Light Electric Vehicle) comprising an LEV connector according to claim 2.
